(19) United States
(12) Patent Application Publication
(10) Pub. No.: US 2025/0123531 A1
(43) Pub. Date: Apr. 17, 2025

(54) ELECTROWETTING DISPLAY PANEL AND DISPLAY DEVICE

(71) Applicant: HKC CORPORATION LIMITED, Shenzhen (CN)

(72) Inventors: LING WANG, Shenzhen (CN); Yilin YANG, Shenzhen (CN); Jialing DU, Shenzhen (CN); Tianzhi QIN, Shenzhen (CN); Cailin QUAN, Shenzhen (CN); Junlin WANG, Shenzhen (CN); Haijiang YUAN, Shenzhen (CN)

(21) Appl. No.: 18/902,246

(22) Filed: Sep. 30, 2024

(30) Foreign Application Priority Data
Oct. 12, 2023 (CN) 202311318111.2

(51) Int. Cl. G02F 1/16755; G02F 1/16766; G02F 1/1677; G02F 1/1685

(52) U.S. Cl. CPC G02F 1/16755; G02F 1/16766; G02F 1/1677; G02F 1/1685

(57) ABSTRACT

An electrowetting display panel includes an upper substrate, a lower substrate opposite to the upper substrate, and multiple separation pieces between the upper and the lower substrate. The upper substrate, the lower substrate, and each separation piece together enclose a cavity, which is divided into a first cavity and a second cavity vertically communicated. The electrowetting display panel further includes a first fluid and a second fluid immiscible with each other. The first fluid is an opaque liquid disposed in the first cavity. The second fluid is a transparent liquid disposed in the second cavity. The first fluid has a density less than that of the second fluid. One of the first fluid and the second fluid is charged. Under an action of the upper and the lower electrode layer, the first fluid and the second fluid are operative to flow between the first and the second cavity.

### CROSS-REFERENCE TO RELATED APPLICATIONS

This application claims the priority and benefit of Chinese patent application number 2023113181112, titled “Electrowetting Display Panel and Display Device” and filed Oct. 12, 2023 with China National Intellectual Property Administration, the entire contents of which are incorporated herein by reference.

### TECHNICAL FIELD

This application relates to the field of display technology, and more particularly relates to an electrowetting display panel and a display device.

### BACKGROUND

The description provided in this section is intended for the mere purpose of providing background information related to the present application but doesn't necessarily constitute prior art.

Electronic paper technology is a new type of display technology. It uses a reflection principle similar to that of paper, and can achieve high definition, low power consumption, strong readability and bendability, and other effects. The display screen of an electronic paper is mainly composed of tiny charged particles. These particles can change their positions according to the changes of electrical signals, thus presenting different images. Electronic paper technology is widely used, such as e-books, electronic tags, and wearable devices. As time goes by, the technical advantages of electronic paper are constantly recognized, and people's requirements for electronic paper display are getting higher and higher, which has led to a variety of technical implementation methods, such as cholesteric liquid crystal display technology, micro-capsules electrophoretic display technology, microcup technology, and electrowetting display technology.

The basic principle of electrowetting electronic paper technology is using the influence of interfacial charges on interfacial tension to change the contact angle of charged ink droplets, so that the droplets can shrink and expand, thereby realizing the role of an optical switch. The electrowetting electronic paper display is mainly composed of an upper and a lower substrate, ink, water, a hydrophobic layer, a pixel wall, and so on. When no driving voltage is applied to the pixel electrode, the ink spreads evenly on the surface of the insulating medium, and the pixel unit presents a completely dark state of the ink color, that is, the pixel is in the “off” state. When a driving voltage is applied to the pixel electrode, the ink begins to shrink and no longer covers the entire pixel. Instead, it shrinks to one side into an oil droplet shape under the action of the driving voltage and surface tension. The pixel unit thus presents a white state that reflects the color of the substrate, that is, the pixel unit is in the “on” state.

The electrowetting display technology may achieve color change by controlling the contraction and expansion of charged ink droplets. On this basis, there is a problem of slow response speed of the display. In addition, since the ink has a certain area after contraction, it will block the reflection effect and reduce the display brightness of the entire screen.

### SUMMARY

It is therefore one purpose of this application to provide an electrowetting display panel and a display device to increase the response speed and improve the display brightness of images.

The present application discloses an electrowetting display panel. The electrowetting display panel includes an upper substrate and a lower substrate disposed opposite to each other. An upper electrode layer is disposed in the upper substrate, and a lower electrode layer is disposed in the lower substrate. The electrowetting display panel further includes a plurality of separation pieces. The plurality of separation pieces are arranged in an array between the upper substrate and the lower substrate, corresponding one to one with pixels in the electrowetting display panel. One end of each separation piece abuts against the upper substrate, and the other end abuts against the lower substrate. The upper substrate, the lower substrate, and each separation piece together enclose a cavity.

The cavity is divided into a first cavity and a second cavity which are connected to each other. The first cavity and the second cavity are stacked and arranged between the upper substrate and the lower substrate. The first cavity is located between the upper substrate and the second cavity. The cross-sectional area of the end of the first cavity adjacent to the second cavity is less than the cross-sectional area of the end adjacent to the upper substrate. The cross-sectional area of the end of the second cavity adjacent to the first cavity is smaller than the cross-sectional area of the end adjacent to the lower substrate. The inner wall of the separation piece corresponding to the first cavity can reflect light. The electrowetting display panel further includes a first fluid and a second fluid that are immiscible with each other. The first fluid is an opaque liquid arranged in the first cavity. The second fluid is a transparent liquid arranged in the second cavity. The density of the first fluid is smaller than the density of the second fluid. One of the first fluid and the second fluid is charged. Under the action of the upper electrode layer and the lower electrode layer, the first fluid and the second fluid flow between the first cavity and the second cavity.

In some embodiments, the separation piece is an axisymmetric structure. The separation piece includes a first separator and a second separator connected to each other. The first cavity is formed between the first separator and the upper substrate. The second cavity is formed between the second separator and the lower substrate. The first separator and the second separator are mirror-image structures.

In some embodiments, along the direction from the upper substrate to the lower substrate, the cross-section of the first cavity gradually decreases, and the cross-section of the second cavity gradually increases.

In some embodiments, the shapes of the first cavity and the second cavity are each in the shape of a truncated cone, a prism, or U-shaped.

In some embodiments, the first fluid is a charged liquid, including a charged black ink or a charged alkane. The second fluid is a non-charged liquid, including water, an anhydrous glycerol, a halogenated alkane, or an organic transparent liquid polymer.

In some embodiments, the separation piece further includes a hollow plate. The hollow plate is arranged at the junction of the first cavity and the second cavity, and is connected to the first separator and the second separator. A plurality of micropores are defined in the hollow plate, and the side of the hollow plate facing the upper substrate can reflect light.

In some embodiments, along the direction toward the lower substrate, the upper substrate includes a first base, the upper electrode layer, and an upper hydrophobic insulating layer that are stacked in sequence. Along the direction toward the upper substrate, the lower substrate includes a second base, the lower electrode layer, and a lower hydrophobic insulating layer that are stacked in sequence. The lower electrode layer includes a pixel electrode and a control circuit that are connected to each other. The separation piece is disposed between the upper hydrophobic insulating layer and the lower hydrophobic insulating layer.

In some embodiments, the upper substrate further includes a color filter, and the color filter is arranged between the first base and the upper electrode layer.

In some embodiments, the lower substrate further includes a reflective layer. The reflective layer is disposed between the second base and the lower electrode layer. The inner wall of the separation piece corresponding to the second cavity can reflect light.

The present application further discloses a display device, which includes a driving circuit and the electrowetting display panel as described above, wherein the driving circuit is used to drive the electrowetting display panel.

Compared with the current electronic paper that changes color by controlling the contraction and expansion of charged ink droplets, the present application changes the internal structure of the pixel, replaces the original electronic ink composed of countless tiny charged particles with a first fluid having a smaller density and a second fluid having a larger density, so that the first fluid and the second fluid are distributed in the first cavity and the second cavity that are communicated to each other. Since the first fluid is an opaque liquid, the second fluid is a transparent liquid, the first fluid and the second fluid are immiscible, and one of the first fluid and the second fluid is charged, there will be no problem of particle condensation between the first fluid and the second fluid and inside the first fluid and inside the second fluid, thereby accelerating the response speed of the display screen.

Furthermore, since the inner wall of the separation piece corresponding to the first cavity reflects light, the cross-sectional area of the end of the first cavity adjacent to the second cavity is less than the cross-sectional area of the end adjacent to the upper substrate, the cross-sectional area of the end of the second cavity adjacent to the first cavity is smaller than the cross-sectional area of the end adjacent to the lower substrate, the opening area of the top portion of the second cavity is small and the internal space is large, when the opaque first fluid moves into the second cavity, the first fluid will be blocked by the separation piece. Furthermore, the inner wall of the separation piece corresponding to the first cavity reflects light, the amount of external light irradiating the interior of the second cavity is relatively small, and the amount absorbed by the first fluid 500 is also relatively small. Therefore, it can solve the problem of impure color display and low light utilization rate caused by ink splitting in the electrowetting type electronic paper, thus avoiding blocking the reflected light after ink shrinkage, thereby facilitating to improve the display brightness.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principle of the present application in conjunction with the text description. Apparently, the drawings in the following description merely represent some embodiments of the present disclosure, and for those having ordinary skill in the art, other drawings may also be obtained based on these drawings without investing creative efforts. Hereinafter the present application will be described in detail with reference to the accompanying drawings and optional embodiments.

FIG. 1 is a schematic cross-sectional view of an electrowetting display panel in a fully dark state according to an embodiment of the present application.

FIG. 2 is a schematic cross-sectional view of an electrowetting display panel in a fully bright state according to an embodiment of the present application.

FIG. 3 is a schematic plan view of a separation piece according to an embodiment of the present application.

FIG. 4 is a schematic cross-sectional view of a separation piece according to an embodiment of the present application.

FIG. 5 is a schematic cross-sectional view of another electrowetting display panel according to an embodiment of the present application.

FIG. 6 is a schematic plan view of another separation piece according to an embodiment of the present application.

FIG. 7 is a schematic cross-sectional view of another electrowetting display panel according to an embodiment of the present application.

FIG. 8 is a schematic view of a display device according to an embodiment of the present application.

In the drawings: 10, display device; 20, driving circuit; 30, electrowetting display panel; 100, upper substrate; 110, first base; 120, upper electrode layer; 130, upper hydrophobic insulating layer; 140, color filter; 200, lower substrate; 210, second base; 220, lower electrode layer; 230, lower hydrophobic insulating layer; 240, reflective layer; 300, separation piece; 310, first separator; 311, reflective surface; 320, second separator; 330, hollow plate; 331, micropore; 400, cavity; 410, first cavity; 420, second cavity; 430, hole; 500, first fluid; 600, second fluid.

### DETAILED DESCRIPTION OF EMBODIMENTS

It should be understood that the terms used herein, the specific structures and function details disclosed herein are intended for the mere purposes of describing specific embodiments and are representative. However, this application may be implemented in many alternative forms and should not be construed as being limited to the embodiments set forth herein.

Furthermore, as used herein, terms “mounted on”, “connected to”, “coupled to”, “connected with”, and “coupled with” should be understood in a broad sense unless otherwise specified and defined. For example, they may indicate a fixed connection, a detachable connection, or an integral connection. They may denote a mechanical connection, or an electrical connection. They may denote a direct connection, a connection through an intermediate, or an internal connection between two elements. For those of ordinary skill in the art, the specific meanings of the above terms as used in the present application can be understood depending on specific contexts.

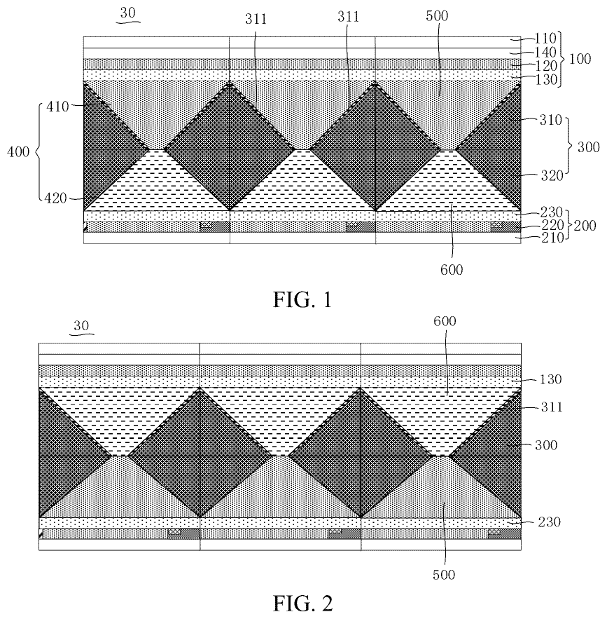

FIG. 1 is a schematic diagram of an electrowetting display panel in a fully dark state according to an embodiment of the present application. FIG. 2 is a schematic diagram of an electrowetting display panel in a fully bright state according to an embodiment of the present application. As shown in FIG. 1 and FIG. 2, an embodiment of the present application provides an electrowetting display panel. The electrowetting display panel 30 includes an upper substrate 100 and a lower substrate 200 arranged opposite to each other.

In the direction toward the lower substrate 200, the upper substrate 100 includes a first base 110, an upper electrode layer 120, and an upper hydrophobic insulating layer 130 stacked in sequence. The first base 110 is made of a transparent material such as glass or plastic. The upper electrode layer 120 adopts a transparent conductive structure such as indium tin oxide (ITO). The upper hydrophobic insulating layer 130 is made of a fluorine-containing polymer, a synthetic polymer melt polymer, or a sol-gel hybrid material, etc, and has desirable waterproof and insulating properties.

When the electrowetting display panel 30 is an electronic paper that only displays black and white images, the upper substrate 100 does not contain a filter structure or other color structures. When the electrowetting display panel 30 is an electronic paper that displays color images, the upper substrate 100 further includes a color filter 140. The color filter 140 is arranged between the first base 110 and the upper electrode layer 120, so that the reflected light passes through the color filter 140 and becomes colored light, realizing the display of a color image. Whether to add a color filter 140 to the electrowetting display panel 30 is selected according to actual conditions and is not limited here. However, it should be understood that whether or not the electrowetting display panel 30 is provided with a color filter 140, it all falls in the scope of protection of the present application.

In the direction toward the upper substrate 100, the lower substrate 200 includes a second base 210, a lower electrode layer 220, and a lower hydrophobic insulating layer 230 stacked in sequence. The second base 210 also uses a transparent material such as glass or plastic. The lower electrode layer 220 includes a plurality of connected pixel electrodes and control circuits. Each pixel includes a pixel electrode and a control circuit, and the corresponding pixel electrode is controlled separately by the respective control circuit. The control circuit includes a thin film transistor structure. The pixel electrode also uses a transparent conductive structure. The lower hydrophobic insulating layer 230 also uses a fluorine-containing polymer, a synthetic polymer melt polymer, or a sol-gel hybrid material, etc.

The electrowetting display panel 30 further includes a plurality of separation pieces 300. The separation pieces 300 are disposed between the upper hydrophobic insulating layer 130 and the lower hydrophobic insulating layer 230, and the separation pieces 300 correspond one-to-one to the pixels in the electrowetting display panel 30.

Each separation piece 300 may be an integral structure. Adjacent separation pieces 300 are attached together. The top of each separation piece 300 abuts against the upper hydrophobic insulating layer 130. The bottom of each separation piece 300 abuts against the lower hydrophobic insulating layer 230. Since the interior of the separation piece 300 is hollow, the upper hydrophobic insulating layer 130, the lower hydrophobic insulating layer 230, and the separation piece 300 together define a sealed cavity 400.

Alternatively, each separation piece 300 may be a split structure. For example, each separation piece 300 may be divided into four parallel and independent partition structures, which are respectively located on four sides of the pixel. The four partition structures form a structure surrounding the pixel, and the partition structures in adjacent pixels are attached. In this case, the four partition structures in the pixel, the upper hydrophobic insulating layer 130, and the lower hydrophobic insulating layer 230 together define a sealed cavity 400. Each separation piece 300 may also be divided into more or less partition structures, as long as the formation conditions of the cavity 400 are met.

Taking the cavity 400 corresponding to one pixel as an example, the cavity 400 is divided into a first cavity 410 and a second cavity 420 that are connected to each other. The first cavity 410 and the second cavity 420 are stacked and arranged between the upper substrate 100 and the lower substrate 200. The first cavity 410 is located between the upper substrate 100 and the second cavity 420. That is, the first cavity 410 is disposed above the second cavity 420.

The cross-sectional area of the end of the first cavity 410 adjacent to the second cavity 420 is less than the cross-sectional area of the end adjacent to the upper substrate 100. It means that the area of the top portion of the first cavity 410 is relatively large and the area of the bottom portion is relatively small. It can be understood that the side of the first cavity 410 may be an uncurved inclined surface, a stepped surface, or a curved surface. Similarly, the cross-sectional area of the end of the second cavity 420 adjacent to the first cavity 410 is smaller than the cross-sectional area of the end adjacent to the lower substrate 200, indicating that the area of the top portion of the second cavity 420 is relatively small and the area of the bottom portion is relatively large.

Furthermore, the inner wall of the separation piece 300 corresponding to the first cavity 410 reflects light thus forming a reflective surface 311,, so that external light can irradiate the inner wall of the separation piece 300 corresponding to the first cavity 410 and can be reflected back.

It can be understood that the inner wall of the separation piece 300 corresponding to the first cavity 410 represents the portion where the first cavity 410 contacts the separation piece 300. Furthermore, the reflective surface 311 may be formed by spraying a reflective coating on, attaching a reflective film to, or adding a reflective structure to the inner wall of the separation piece 300 corresponding to the first cavity 410,, or even making the separation piece 300 out of a reflective material.

The electrowetting display panel 30 further includes a first fluid 500 and a second fluid 600 that are immiscible with each other. The first fluid 500 is an opaque liquid. In a non-display state, the first fluid 500 is contained in the first cavity 410. The second fluid 600 is a transparent liquid. In the non-display state, the second fluid 600 is contained in the second cavity 420. The density of the first fluid 500 is less than the density of the second fluid 600. One of the first fluid 500 and the second fluid 600 is charged. Under the action of the upper electrode layer 120 and the lower electrode layer 220, the first fluid 500 and the second fluid 600 flow between the first cavity 410 and the second cavity 420. It may be that the electric field formed between the upper electrode layer 120 and the lower electrode layer 220 directly controls the movement of the first fluid 500, and at the same time, the first fluid 500 pushes the second fluid 600 to move. Alternatively, the electric field formed between the upper electrode layer 120 and the lower electrode layer 220 directly controls the movement of the second fluid 600, and at the same time, the second fluid 600 pushes the first fluid 500 to move.

The first fluid 500 may be a charged liquid, and the second fluid 600 is an uncharged liquid. The electric field directly controls the movement of the opaque first fluid 500, making the image change more obvious and making the display response faster. Specifically, the first fluid 500 may be a charged black ink or a charged alkane (alkane liquid similar to hexadecane), etc. The second fluid 600 may be water, anhydrous glycerol, halogenated alkane, or an organic transparent liquid polymer, etc.

In a possible electronic paper, the particles of an electronic ink are formed by many black and white particles with positive and negative charges sealed in internal liquid microcapsules. The image display is realized by controlling the movement of black particles and white particles, where the charged particles therein may condense under the action of static electricity, resulting in a slower response time. The present application changes the internal structure of the pixel, replaces the original electronic ink composed of countless tiny charged particles with a first fluid 500 having a smaller density and a second fluid 600 having a larger density, so that the first fluid 500 and the second fluid 600 are distributed in the first cavity 410 and the second cavity 420 that are communicated to each other.

Since the first fluid 500 is an opaque liquid, the second fluid 600 is a transparent liquid, the first fluid 500 and the second fluid 600 are immiscible, and one of the first fluid 500 and the second fluid 600 is charged, there will be no problem of particle condensation between the first fluid 500 and the second fluid 600 and inside the first fluid 500 and inside the second fluid 600, thereby accelerating the response speed of the display screen.

When the electrowetting display panel 30 does not display an image, no electric field is formed between the upper electrode layer 120 and the lower electrode layer 220. In this case, the opaque first fluid 500 flows into the upper first cavity 410 due to its relatively low density, and the transparent second fluid 600 flows into the lower second cavity 420 due to its relatively high density, so that the external light irradiated on the first fluid 500 cannot be reflected back, so that no image would be displayed.

When the electrowetting display panel 30 displays an image, an electric field is formed between the upper electrode layer 120 and the lower electrode layer 220. Under the action of the electric field, the first fluid 500 flows toward the second cavity 420 below, and pushes the second fluid 600 originally contained in the second cavity 420 to flow toward the above first cavity 410. By controlling the magnitude of the electric field, the volume of the first fluid 500 entering the second cavity 420 is adjusted. When all the first fluid 500 enters the second cavity 420, the brightness of the electrowetting display panel 30 is the highest at this time.

Furthermore, since the inner wall of the separation piece 300 corresponding to the first cavity 410 reflects light, and the cross-sectional area of the end of the first cavity 410 adjacent to the second cavity 420 is less than the cross-sectional area of the adjacent close to the upper substrate 100, it means that the inner wall of the separation piece 300 corresponding to the first cavity 410 is contracted in the direction toward the second cavity 420, and the external light will be reflected back after irradiating the inner wall of the separation piece 300 corresponding to the first cavity 410. When the electrowetting display panel 30 does not display an image, since the first fluid 500 is in the first cavity 410, the first fluid 500 blocks the reflective structure around the first cavity 410. At this time, the interior of the separation piece 300 cannot reflect the external light, so that the screen is completely dark. When the electrowetting display panel 30 displays an image, the transparent second fluid 600 flows into the first cavity 410. The external light passes through the second fluid 600 and irradiates on the inner wall of the separation piece 300 corresponding to the first cavity 410, and will be reflected back to display an image.

When the opaque first fluid 500 moves into the second cavity 420, due to the small top opening area and large internal space of the second cavity 420, the first fluid 500 will be blocked by the separation piece 300 after moving into the second cavity 420. Furthermore, the inner wall of the separation piece 300 corresponding to the first cavity 410 reflects light, the amount of external light irradiating the interior of the second cavity 420 is relatively small, and the amount absorbed by the first fluid 500 is also relatively small. Therefore, it can solve the problem of impure color display and low light utilization rate caused by ink splitting in the electrowetting type electronic paper, thus avoiding blocking the reflected light after ink shrinkage, thereby facilitating to improve the display brightness.

In addition, when the electrowetting display panel 30 displays a color image, since the embodiments of the present application use a single pixel to display a single color, it avoids the adverse effects in the SiPix microcup display technology due to the performance setbacks caused by the fact that different voltages need to be applied to the transparent electrode in different time periods to control the color change, which places high requirements on the signal timing adjustment.

In the embodiments of the present application, the separation piece 300 is made of glass, a transparent resin, a transparent plastic, or a metal, and is fixed onto the upper substrate 100 or the lower substrate 200 by nested structure fixation, nanoimprinting, bonding, etc.

Furthermore, the separation piece 300 is an axisymmetric structure. As a specific embodiment, the separation piece 300 is a split structure, divided into upper and lower parts, specifically including a first separator 310 and a second separator 320 that are connected to each other. The first cavity 410 is defined between the first separator 310 and the upper substrate 100. The second cavity 420 is defined between the second separator 320 and the lower substrate 200. The first separator 310 and the second separator 320 are mirror structures. In this case, the first cavity 410 and the second cavity 420 are also mirror structures. The volume of the first fluid 500 is the same as that of the second fluid 600, so that the diffusion effects of the first liquid and the second liquid into the respective opposite cavities 400 are the same, making the display effect more uniform.

Further, as shown in FIG. 1 and FIG. 2, along the direction from the upper substrate 100 to the lower substrate 200, the cross section of the first cavity 410 gradually decreases, and the cross section of the second cavity 420 gradually increases. In this case, the inner walls of the separation piece 300 corresponding to the first cavity 410 are inclined surfaces, and are inclined upward, and the reflective surface is also inclined upward. Under the action of an electric field, the first fluid 500 and the second fluid 600 move and transfer along the inner walls of the separation piece 300, which is conducive to speeding up the transfer speed and achieving the effect of improving the screen response speed. In addition, the inclined reflective design can widen the viewing angle. It should be noted that when a reflector is provided on the inner wall of the separation piece 300 corresponding to the first cavity 410, the reflector is embedded in the inner wall of the separation piece 300, so that the inner surface of the nested separation piece 300 is a flat inclined surface without protrusions and depressions, thereby avoiding the occurrence of residual first fluid 500 or incomplete shrinkage resulting in uneven pixel color display.

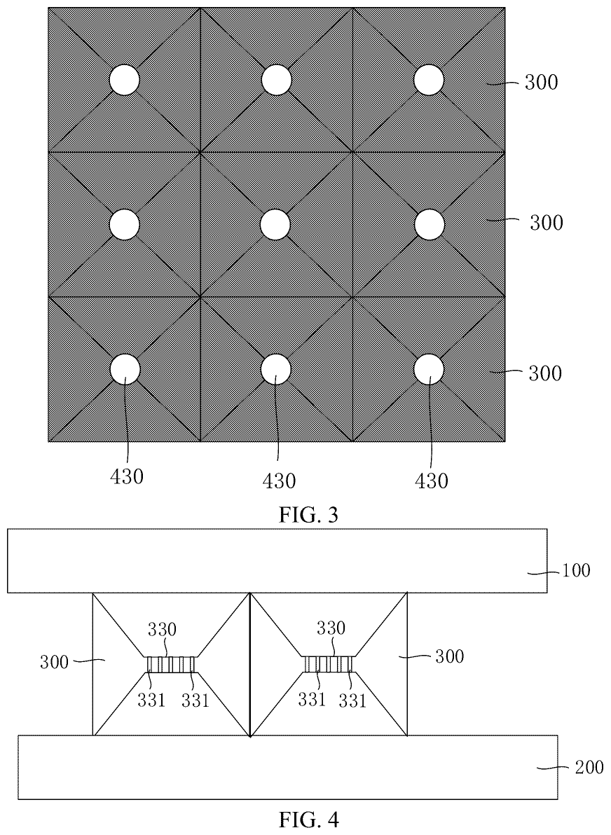

As shown in FIG. 1 and FIG. 3, the first cavity 410 is in the shape of an inverted quadrangular pyramid, the second cavity 420 is in the shape of a regular quadrangular pyramid. The first cavity 410 and the first separator 310 are combined to form a square, and the second cavity 420 and the second separator 320 are combined to form a square. There is a hole 430 at the junction between the first cavity 410 and the second cavity 420, and the first fluid 500 and the second fluid 600 enter the opposite cavities 400 through the hole 430.

As a further implementation, as shown in FIG. 4, the separation piece 300 further includes a hollow plate 330. The hollow plate 330 is disposed at the junction of the first cavity 410 and the second cavity 420, disposed in the hole 430, and connected to the first separator 310 and the second separator 320. Specifically, it may be integrally formed with the first separator 310 and the second separator 320. The hollow plate 330 defines a plurality of micropores 331, and the side of the hollow plate facing the upper substrate 100 can reflect light. Through the above design, when the electrowetting display panel 30 is in the display state, the external light irradiated on the hollow plate 330 can be reflected back, thereby increasing the amount of reflected light, and the micropores 331 in the hollow plate 330 will not affect the flow of the first fluid 500 and the second fluid 600, thereby preventing the situation that the first fluid 500 located in the second cavity 420 moves directly below the hole 430 when the electrowetting display panel 30 is in the display state resulting in the light not being reflected thus affecting the brightness or even causing the problem of dark spots.

Furthermore, as another design, the inclination angles of the inner sides of the first separator 310 at various positions may be made equal, and the inclination angles of the inner sides of the first separator 310 at various positions may also be made the equal. The first cavity 410 and the second cavity 420 may be set to be truncated cone-shaped.

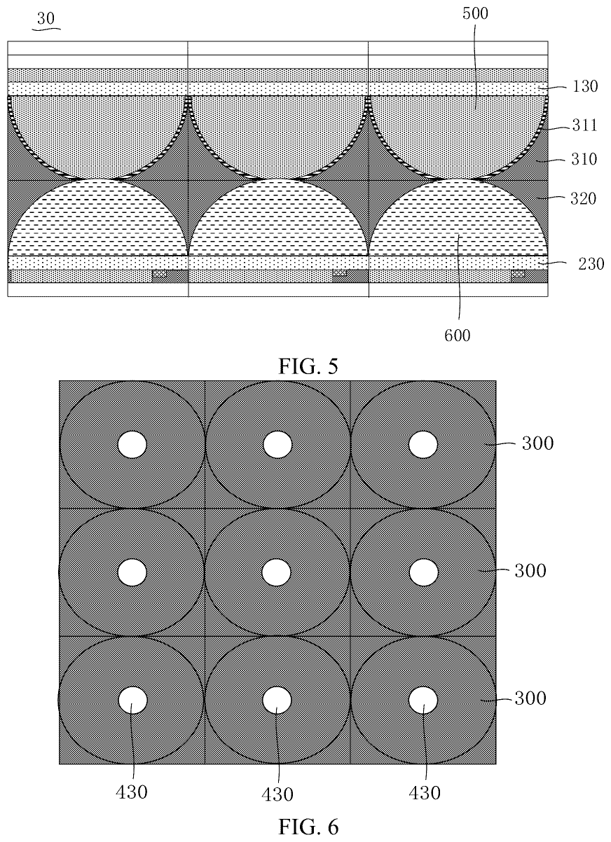

As shown in FIG. 5 and FIG. 6, as another embodiment, the inner wall of the separation piece 300 is a curved surface, the reflective structure on the inner wall of the first separator 310 is also a curved surface, the first cavity 410 and the second cavity 420 are hemispherical, and the entire cavity 400 forms an hourglass shape. At this time, after the external light vertically enters the inner wall of the separation piece 300 corresponding to the first cavity 410, it can be vertically reflected, so that the light output effect is uniform. At the same time, it can also widen the viewing angle, improve the utilization rate of light, and facilitate the flow of the first fluid 500. Of course, the inner wall of the separation piece 300 may be adjusted so that the first cavity 410 and the second cavity 420 form a U-shaped structure or other shapes, which may be selected according to actual requirements.

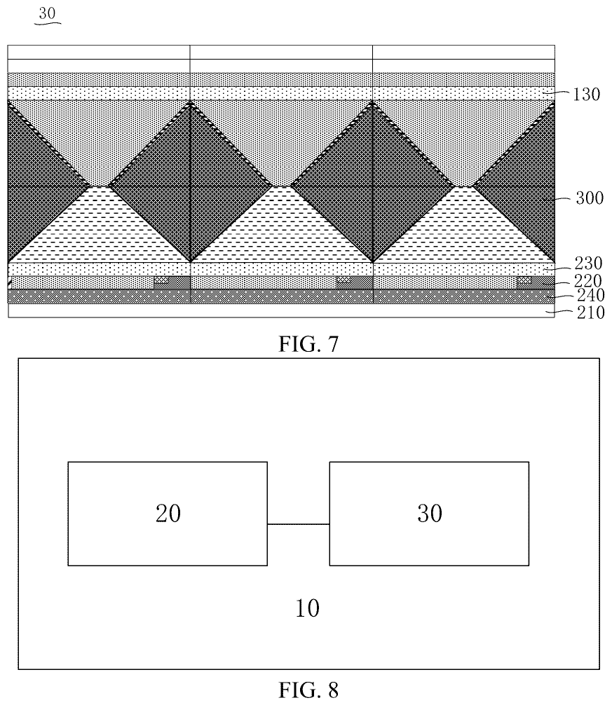

As shown in FIG. 7, as a further implementation, the lower substrate 200 further includes a reflective layer 240. The reflective layer 240 is disposed between the second base 210 and the lower electrode layer 220. The inner wall of the separation piece 300 corresponding to the second cavity 420 can reflect light. In this case, the side walls of the separation piece 300 all reflect light, and the bottom of the cavity 400 will also reflect light. When the electrowetting display panel 30 is in a completely dark state, the first fluid 500 is in the first cavity 410, and the external light will not hit the reflective structure, and no light will be reflected. When the electrowetting display panel 30 is in a fully bright state, all the first fluid 500 enters the second cavity 420, and the external light passes through the second fluid 600 to hit the inner wall of the first separator 310 and is reflected back. When the electrowetting display panel 30 displays in a normal brightness, the first fluid 500 is mixed both in the first cavity 410 and the second cavity 420, and the external light passes through the second fluid 600 to hit the inner wall of the first separator 310 and is reflected back, and also passes through the hole 430 to hit the reflective layer 240 of the lower substrate 200 and is reflected back, or is reflected to the inner wall of the second separator 320 and then reflected back, which is conducive to improving the light utilization rate.

The embodiments of the present application also provide a method for manufacturing the above electrowetting display panel 30, by the following specific operations:
A: depositing a color filter (if black and white display is selected, this operation can be omitted) and a transparent conductive film on the first base in sequence to form an upper electrode layer; depositing corresponding film layers on the second base, and patterning the corresponding film layers using a possible process to form a lower electrode layer, the lower electrode layer including a pixel electrode and a control circuit (the specific process is not to be described in detail);
B: depositing a hydrophobic insulating material on each of the upper electrode layer and the lower electrode layer to form an upper hydrophobic insulating layer and a lower hydrophobic insulating layer, thus completing the manufacturing process of the upper substrate and the lower substrate;
C: arranging the second separator on the lower substrate;
D: arranging the first separator on the second separator and aligning it with the second separator on a one by one basis;
E: filling the first separator and the second separator with the first fluid and the second fluid; and
F: attaching the upper substrate to the first separator to obtain the electrowetting display panel.

Of course, depending on different designs of the separation piece 300, the above operations can also be adjusted. Furthermore, it will not be deemed to limit the order of the operations, provided that they do not affect the implementation of the specific solution, so that the operations written earlier may be executed earlier or they may also be executed later. The schemes of different embodiments can be combined and applied should no conflict occurs, and as long as the present solution can be implemented, they should all be regarded as falling in the scope of protection of this application.

In addition, as shown in FIG. 8, the present application further discloses a display device, wherein the display device 10 includes a driving circuit 20 and the electrowetting display panel 30 as described above, and the driving circuit 20 is used to drive the electrowetting display panel 30. The display products provided in the embodiments of the present application have high response speed and high display brightness, and have great market competitiveness.

The foregoing description is merely a detailed description of the present application with reference to some specific illustrative embodiments, and the specific implementations of the present application are not to be construed to be limited to these illustrative embodiments. For those having ordinary skill in the technical field to which this application pertains, numerous simple deductions or substitutions may be made without departing from the concept of this application, which shall all be regarded as falling in the scope of protection of this application.

What is claimed is:

1. An electrowetting display panel, comprising:
an upper substrate, comprising an upper electrode layer;
a lower substrate, arranged opposite to the upper substrate and comprising a lower electrode layer;
a plurality of separation pieces, which are arranged in an array between the upper substrate and the lower substrate, and are arranged in one-to-one correspondence with a plurality of pixels in the electrowetting display panel; wherein one end of each of the plurality of separation pieces abuts against the upper substrate, and another end of the separation piece abuts against the lower substrate, wherein the upper substrate, the lower substrate, and the separation piece collectively enclose a cavity; wherein the cavity is divided into a first cavity and a second cavity that are communicated to each other, wherein the first cavity and the second cavity are stacked and arranged between the upper substrate and the lower substrate, wherein the first cavity is located between the upper substrate and the second cavity, and a cross-sectional area of an end of the first cavity adjacent to the second cavity is less than a cross-sectional area of another end of the first cavity adjacent to the upper substrate, wherein a cross-sectional area of an end of the second cavity adjacent to the first cavity is less than a cross-sectional area of another end of the second cavity adjacent to the lower substrate; wherein each of the plurality of separation pieces comprises an inner wall that is disposed corresponding to the first cavity and that is operative to reflect light; and
a first fluid and a second fluid that are immiscible with each other, wherein the first fluid is an opaque liquid and is disposed in the first cavity; wherein the second fluid is a transparent liquid and is disposed in the second cavity, and the first fluid has a density that is less a density of the second fluid; wherein one of the first fluid and the second fluid is charged, wherein under an action of the upper electrode layer and the lower electrode layer, the first fluid and the second fluid are operative to flow between the first cavity and the second cavity.

2. The electrowetting display panel as recited in claim 1, wherein each of the plurality of separation pieces is of an axisymmetric structure, wherein the separation piece comprises a first separator and a second separator connected to each other, wherein the first separator and the upper substrate jointly define the first cavity, wherein the second separator and the lower substrate jointly define the second cavity, wherein the first separator and the second separator are mirror-image structures with respect to each other.

3. The electrowetting display panel as recited in claim 2, wherein in a direction from the upper substrate to the lower substrate, a cross section of the first cavity gradually decreases, and a cross section of the second cavity gradually increases.

4. The electrowetting display panel as recited in claim 3, wherein an inner side surface of each of the first cavity and the second cavity is an inclined surface.

5. The electrowetting display panel as recited in claim 4, wherein the first cavity and the second cavity are each in the shape of a truncated cone.

6. The electrowetting display panel as recited in claim 4, wherein the first cavity and the second cavity are each in the shape of a prism.

7. The electrowetting display panel as recited in claim 3, wherein an inner side surface of each of the first cavity and the second cavity is a curved surface.

8. The electrowetting display panel as recited in claim 7, wherein the first cavity and the second cavity are each U-shaped.

9. The electrowetting display panel as recited in claim 7, wherein the first cavity and the second cavity are each hemispheric.

10. The electrowetting display panel as recited in claim 3, wherein an inner side surface of each of the first cavity and the second cavity is a stepped surface.

11. The electrowetting display panel as recited in claim 1, wherein the first fluid is a charged liquid, comprising a charged black ink or a charged alkane; wherein the second fluid is a non-charged liquid, including water, an anhydrous glycerol, a halogenated alkane, or an organic transparent liquid polymer.

12. The electrowetting display panel as recited in claim 2, wherein each of the plurality of separation pieces further comprises a hollow plate, wherein the hollow plate is disposed at a junction of the first cavity and the second cavity and is connected to the first separator and the second separator; wherein there is defined a plurality of micropores in the hollow plate, and wherein a side of the hollow plate facing the upper substrate is operative to reflect light.

13. The electrowetting display panel as recited in claim 12, wherein the hollow plate is integrally formed with the first separator and the second separator.

14. The electrowetting display panel as recited in claim 1, wherein in a direction pointing to the lower substrate, the upper substrate comprises a first base, the upper electrode layer, and an upper hydrophobic insulating layer that are stacked in sequence; wherein in a direction pointing to the upper substrate, the lower substrate comprises a second base, the lower electrode layer, and a lower hydrophobic insulating layer that are stacked in sequence, wherein the lower electrode layer comprises a pixel electrode and a control circuit that are connected, wherein the plurality of separation pieces are arranged between the upper hydrophobic insulating layer and the lower hydrophobic insulating layer.

15. The electrowetting display panel as recited in claim 14, wherein the upper substrate further comprises a color filter disposed between the first base and the upper electrode layer.

16. The electrowetting display panel as recited in claim 14, wherein the lower substrate further comprises a reflective layer arranged between the second base and the lower electrode layer, wherein an inner wall of each the plurality of separation pieces corresponding to the respective second cavity is operative to reflect light.

17. The electrowetting display panel as claimed in claim 1, wherein each of the plurality of separation pieces is of an integral structure, and wherein adjacent separation pieces are attached to each other.

18. The electrowetting display panel as recited in claim 1, wherein each of the plurality of separation pieces is made of a reflective material.

19. An electrowetting display panel, comprising:
an upper substrate; and
a lower substrate, arranged opposite to each other; wherein in a direction pointing to the lower substrate, the upper substrate comprises a first base, an upper electrode layer, and an upper hydrophobic insulating layer that are stacked in sequence; wherein in a direction pointing to the upper substrate, the lower substrate comprises a second base, a lower electrode layer, and a lower hydrophobic insulating layer that are stacked in sequence, wherein the lower electrode layer comprises a pixel electrode and a control circuit that are connected to each other;
a plurality of separation pieces, wherein the plurality of separation pieces are arranged in an array between the upper hydrophobic insulating layer and the lower hydrophobic insulating layer, and are arranged in one-to-one correspondence with a plurality of pixels in the electrowetting display panel; wherein each of the plurality of separation pieces is of an axisymmetric structure, wherein the separation piece comprises a first separator and a second separator connected to each other, wherein the first separator and the upper hydrophobic insulating layer jointly define a first cavity, and wherein the second separator and the lower hydrophobic insulating layer jointly define a second cavity, wherein the first separator and the second separator are mirror-image structures with respect to each other; wherein in a direction pointing from the upper substrate to the lower substrate, a cross section of the first cavity gradually decreases, and a cross section of the second cavity gradually increases; wherein an inner wall of each of the plurality of separation pieces corresponding to the first cavity is operative to reflect light; and
a first fluid and a second fluid that are immiscible with each other, wherein the first fluid is a charged opaque liquid and is disposed in the first cavity; wherein the second fluid is an uncharged transparent liquid and disposed in the second cavity; wherein the first fluid has a density that is less than a density of the second fluid; wherein one of the first fluid and the second fluid is charged, wherein under an action of the upper electrode layer and the lower electrode layer, the first fluid and the second fluid are operative to flow between the first cavity and the second cavity.

20. A display device, comprising an electrowetting display panel and a driving circuit used to drive the electrowetting display panel, wherein the electrowetting display panel comprises:
an upper substrate, comprising an upper electrode layer;
a lower substrate, arranged opposite to the upper substrate;
a plurality of separation pieces, which are arranged in an array between the upper substrate and the lower substrate, and are arranged in one-to-one correspondence with a plurality of pixels in the electrowetting display panel; wherein one end of each of the plurality of separation pieces abuts against the upper substrate, and another end of the separation piece abuts against the lower substrate, wherein the upper substrate, the lower substrate, and the separation piece collectively enclose a cavity; wherein the cavity is divided into a first cavity and a second cavity that are communicated to each other, wherein the first cavity and the second cavity are stacked and arranged between the upper substrate and the lower substrate, wherein the first cavity is located between the upper substrate and the second cavity, and a cross-sectional area of an end of the first cavity adjacent to the second cavity is less than a cross-sectional area of another end of the first cavity adjacent to the upper substrate, wherein a cross-sectional area of an end of the second cavity adjacent to the first cavity is less than a cross-sectional area of another end of the second cavity adjacent to the lower substrate; wherein an inner wall of each of the plurality of separation pieces corresponding to the first cavity is operative to reflect light; and
a first fluid and a second fluid that are immiscible with each other, wherein the first fluid is an opaque liquid and is disposed in the first cavity; wherein the second fluid is a transparent liquid and is disposed in the second cavity, and the first fluid has a density that is less a density of the second fluid; wherein one of the first fluid and the second fluid is charged, wherein under an action of the upper electrode layer and the lower electrode layer, the first fluid and the second fluid are operative to flow between the first cavity and the second cavity.
